(19) United States
(12) Patent Application Publication
(10) Pub. No.: US 2011/0121700 A1
(43) Pub. Date: May 26, 2011

(54) Adjustable Toe Plate for Application in Suspended Cabinet Systems

(76) Inventor: Larry S. Porter, Winnie, TX (US)

(21) Appl. No.: 12/573,966

(22) Filed: Oct. 6, 2009

(51) Int. Cl. A47B 96/00; B23P 11/00

(52) U.S. Cl. 312/246; 312/245; 29/407.05

(57) ABSTRACT

The present disclosure describes a suspended cabinet system having a base cabinet affixed to a wall with a leveled mounting bracket for suspending the cabinet from the floor surface to provide a level counter top surface regardless of imperfections or uneven floors. Further, an adjustable kick plate may be mounted under the cabinet to enclose the lower exposed recess. Still further, one or more side panels may be utilized to cover the exposed sides of the cabinet to provide a finished and a more aesthetically appealing appearance.

### TECHNICAL FIELD

The present disclosure generally relates to a cabinet system and methods of use and, more particularly, to a suspended cabinet system having an adjustable toe plate for the level installation of prefabricated and/or custom cabinetry regardless of imperfections of and/or uneven surfaces of the surface underneath or behind the mounted cabinets.

### BRIEF DESCRIPTION OF DRAWINGS

For a further understanding of the nature and objects of the instant disclosure, reference should be had to the following detailed description, taken in conjunction with the accompanying drawings, in which like elements are given the same or analogous reference numbers.

FIG. 1 illustrates a side perspective view of one embodiment of the cabinet system in accordance with the present disclosure;

FIG. 2 illustrates an end view of an embodiment of the wall support and the back flange in accordance with the present disclosure;

FIG. 3 illustrates an end view of an embodiment of the back flange in accordance with the present disclosure;

FIG. 4 illustrates an end view of an embodiment of the adjustable bottom plate in accordance with the present disclosure;

FIG. 5A illustrates a top view of an embodiment of the wallend adapter in accordance with the present disclosure; and

FIG. 5A illustrates a side view of an embodiment of the wallend adapter in accordance with the present disclosure.

### DETAILED DESCRIPTION OF EMBODIMENTS

It has always been preferred to install cabinets as well as other apparatuses typically intended to be supported by a floor surface, in a substantially level manner. This is especially the case for cabinets which typically have a top surface which is generally mounted on the cabinet. Further, a cabinet surface may have a cutout provided for a sink, stove, or other object. This top surface virtually can not be level if the cabinet itself is not level. A primary obstacle preventing the leveled mounting of a cabinet or other object is the almost inherently uneven or sloping floor. Often floors are not plumb or perfectly flat, yet it is important that for all floor supported apparatuses, the legs or supports of the apparatus contact the floor to provide adequate support and to equally distribute the weight of the object. If all the legs do not contact the floor, many problems can develop. For example, the outer cabinet and frame of an apparatus may become distorted over time due to nonuniform weight support, thereby impairing the proper operation of the apparatus. Annoying “rocking” problems with an apparatus may also result where the legs do not all contact the floor. Moreover, installations that are not level may be aesthetically undesirable by the inability to match the heights of adjacent cabinets, other equipment, or work surfaces.

Installers and manufacturers have attempted to resolve the leveling problem by developing approaches to compensate for uneven and sloping floors. These attempts have ranged from repairing or altering the floor surface, using adjustable legs or supports, using shims or wedges made of a suitable material under the legs or supports, attaching various leveling devices, and other approaches based on contact between the floor surface and the object to be leveled. These techniques have numerous drawbacks. Among them, the apparatus must be manually lifted while such level compensating devices are placed under the legs or supports, thereby often requiring more than one installer. This situation also increases the potential risk of back or other physical injuries to the installers. Further, the shims are not permanently mounted to the apparatus legs and may shift over time or become completely dislodged. The present disclosure eliminates the need to compensate uneven or otherwise unlevel surfaces in a manner that does not require contacting the floor surface for support.

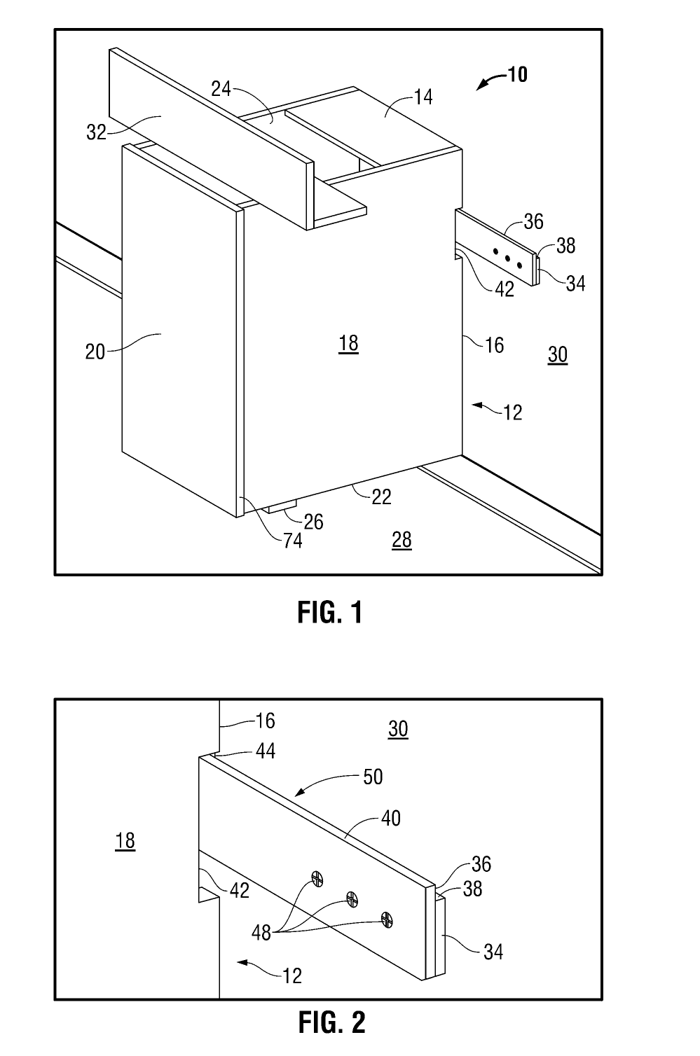

FIG. 1 illustrates a side perspective view of one embodiment of the cabinet system 10. Cabinet 12 may be a conventional cabinet or a custom made cabinet. Typically, cabinet 12 is the type that may be installed in a kitchen. However, it should be appreciated that cabinet 12 may be installed in a variety of rooms in a house, an office, a work shop, or the like. It should be further appreciated that the cabinet system 10, described herein, may also be applied to a variety of wall supported cabinetry, desks, and other furniture. It should be understood that cabinet 12 may be of a variety of materials and designs and that the specific design and/or use of the cabinet 12 does not form a part of this specification. However, the mounting features (the cabinet system 10) described in detail herein do form a part of the disclosure and may be adapted to most conventional and or custom cabinetry and other wall supported furniture like structures. Preferably, cabinet 12 will have an upper surface 14, a back surface 16, side surfaces 18, a front surface 20 and a bottom surface 22.

Upper surface 14 is typically topped by a countertop (not shown). The countertop may be of a variety of conventional materials as well as special order materials which may be aesthetic, resist wear, scratches, heat, be chemical resistant and the like. Thus, the countertop in and of itself does not form a part of the specification herein and will not be described in detail. Upper surface 14 may also have a cutout 24 therein. Cutout 24 may be for the insertion of a sink (not shown), a stove top (not shown), a storage area, or a variety of other apparatuses that may be desired to be within and/or flush with upper surface 14 or any type of countertop placed thereon. Thus, it should be appreciated that upper surface 14 must be substantially level. Further, if the cabinet 12 is placed adjacent to an existing cabinet or adjacent to another new cabinet, upper surface 14 and any countertop attached thereto should be substantially the same in height and levelness as any adjacent cabinet.

Cabinet 12 preferably has two side surfaces 18. It should be appreciated that it is possible to have a cabinet 12 with less than two side surfaces 18. It should be further appreciated that when cabinet 12 is installed adjacent to other cabinets a full side surface 18 may not be necessary or desired. It should be appreciated that typically side surfaces 18 are needed to provide support for the cabinet 12 structure. It should also be appreciated that if cabinet 12 is to be installed where side surface 18 is completely exposed, side surface 18 or a facade attached to side surface 18 may extend to the floor surface 28.

Preferably, attached to the bottom surface 22 is a support 26. Support 26 is preferably recessed from the front surface 20. Support 26 is typically of the same material as cabinet 12. However, support 26 may be of other material as desired. For conventional cabinets 12, the support 26 may be recessed, from the front surface by three (3) or four (4) inches. It should be understood, by those skilled in the art, that support 26 is typically the attachment place for the toe plate 32. The unique toe plate 32 of the instant disclosure is described more fully hereinbelow. Preferably, support 26 makes no contact with the floor surface 28, directly or indirectly. However, it should be appreciated that it may be desired, in some circumstances that support 26 does contact the floor surface 28 in order to share the weight support of the cabinet 12 with the back support flange 34.

Still referring to FIG. 1, back surface 16 preferably mounts adjacent wall 30. It should be understood that wall 30 can be any surface against which cabinet 12 is mounted. Preferably, back support flange 34 is attached to wall 30. It should be understood that the back support flange 34 can be attached to wall 30 in a variety of ways including, but not limited to, screws, nails, bolts, glue, and the like. Preferably, back support flange 34 is of a wooden material. However, it should be appreciated that the back support flange can be of a variety of materials with a suitable strength to at least partially support cabinet 12. Back surface 16 defines a mounting groove 42 which preferably mates with back support flange 34. It should be understood, by those skilled in the art, that there should be some space tolerance between the mounting groove 42 and the back support flange 34 to compensate for any unevenness or waviness of wall 30.

FIG. 2 illustrates further detail of back support flange 34 and mounting groove 42. Back support flange 34 is illustrated as being attached to wall 30 in a preferred mode of screws 48. Preferably, screws 48 are attached to studs (not shown) or other structural supports behind wall 30. It should be appreciated that if wall 30 is of sufficient strength to at least partially support cabinet 12, the mounting screws or other desired attachment devices can be attached to wall 30 without the need of studs or other structural supports. Back support flange 34 preferably has an upper flange support system 50. The upper flange support system 50 preferably includes at least a contact surface 38 and an upper flange lip 36 which extends substantially perpendicular to contact surface 38. At the top of the upper flange lip 36 is a second contact area 40. It should be appreciated, that in use, cabinet 12 is at least partially supported on contact surface 38 and/or second contact area 40.

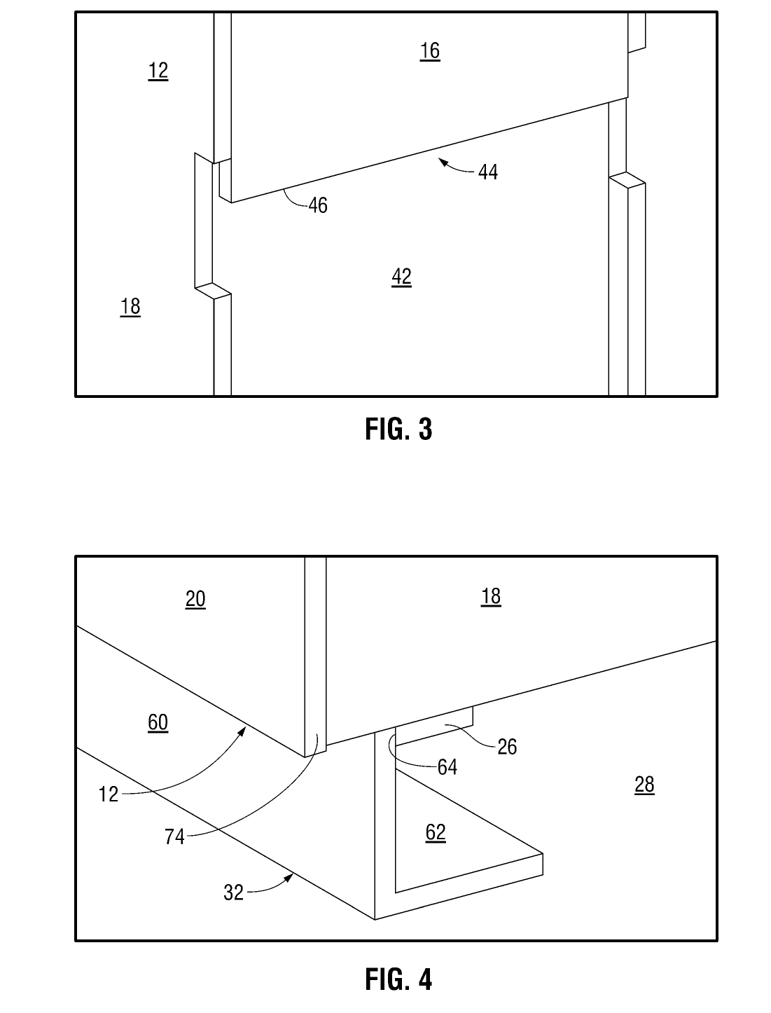

Referring now to FIG. 3 mounting groove 42 is illustrated in further detail. Mounting groove 42 preferably extends substantially the entire length of back surface 16. The upper end of mounting groove 42 includes a back lip 44 which preferably extends downward and substantially parallel to back surface 16. The back lip 44 is spaced apart from back surface 16 a distance that is slightly greater than the width of the second contact area 40. Further, back lip 44 is preferably of a width that is similar to the width of contact surface 38. Thus, when the back support flange 34 is mounted to wall 30, lip contact area 46, of back lip 44, will at least partially engage at least part of contact surface 38 and be supported thereby. Still further, it should be understood that this arrangement will allow cabinet 12 to slide along the back support flange 34 for optimal positioning as well as to compensate for wall waviness.

Referring again to FIG. 1 and more particularly FIG. 4, there is illustrated a toe plate 32. Toe plate 32 is novel in that it can be used bi-directionally depending on the width of the space between the floor 28 and the bottom support 26. Further, toe plate 32 is so designed is to allow adjustment between a levelly installed cabinet 12 and an uneven and/or sloped floor 28. A conventional cabinet is typically designed with approximately a 3½″ recess from the front surface 20 to the toe plate 32. Further, in the conventional cabinet the bottom of the front surface 20 is approximately 4″ above the floor 28. Thus, the conventional toe plate is typically a one piece planar board that is approximately 4″ in height. It should be understood that the dimensions recited herein are for ease of understanding and are not intended as being limited. It should be further understood that these dimensions may vary due to personal preferences, locations of the cabinets, as well as desired cabinet height and positioning.

The novel toe plate 32, described herein, preferably includes two (2) planar sections 60, 62 joined so as to be substantially perpendicular to each other. As described hereinabove for materials of the cabinet 12 and the back support flange 34, toe plate 32 is preferably wood but may be of a variety of materials. It should be understood, by those skilled in the art, that the joining of the two planar sections 60, 62 can be made in a variety of conventional means as well as utilizing unique or custom methods. Preferably, one of the two planar sections 60 is substantially the height of a conventional one piece planar toe plate and the second section 62 is of a height greater than the height of a conventional one piece planar toe plate. Thus, the second section 62 is made to be adjustable in situations where an uneven or unlevel floor 28 prevent a conventional toe plate from evenly contacting floor 28. It should be understood, by those skilled in the art, that in a conventional cabinet installation, wherein, the cabinet is supported by floor 28, an uneven or unlevel floor 28 presents many difficulties with cabinet installation. Typically, cabinet installers must somehow compensate for the unevenness of floors in a variety of time consuming methods. The simplest method is to level the cabinet with a series of shims, attach the toe plate and then add some moulding between the bottom of the toe plate and the floor to hide the unevenness of the floor. However, the methods may become increasingly difficult, expensive, and time consuming if the floor is very uneven or very unlevel. These methods may include, but are not limited to, custom making moulding to hide the floor imperfections, cutting/altering the bottom side edges of the cabinet until a “close enough” fix has been obtained.

The toe plate 32, disclosed herein, eliminates the need for expensive and time consuming methods for hiding any floor imperfections. Preferably, toe plate 32 is attached to bottom support 26. Depending on the condition of floor 28, either planar section 60 (substantially the conventional toe plate height) or planar section 62 (adjustable height) is attached to bottom support 26. The method of attachment, of the toe plate 32 to the side surface 64 of the bottom support 26 can include a variety of fastening devices such as, but not limited to, nails, screws, bolts, glue, pins, and the like. The exact method of attachment of toe plate 32 to bottom support 26 is not intended to be read as a limitation herein. It should be understood, by those skilled in the art, that a further advantage and novelty of toe plate 32 rests in the adjustability of the cabinet system for special adaption such as, but not limited to, meeting the height of an adjacent existing cabinet, meeting disability standards for heights, and the like. In a typical installation, if a cabinet is too short, it is shimmed to meet the desire height. However, if the cabinet is too tall, the exterior sides of the cabinet must be trimmed at the respective bottom edges. This becomes very time consuming and expensive and can result in damage to the cabinet which results in even further expense. However, by utilizing the suspended cabinet system 10 in conjunction with toe plate 32, the cabinet height is easily adjusted and the adjustable toe plate 32 is used to compensate for the distance between the cabinet 12 and the floor 28. Thus, cabinet system 10 used in combination with adjustable toe plate 32 results in a substantially, aesthetically perfect installation.

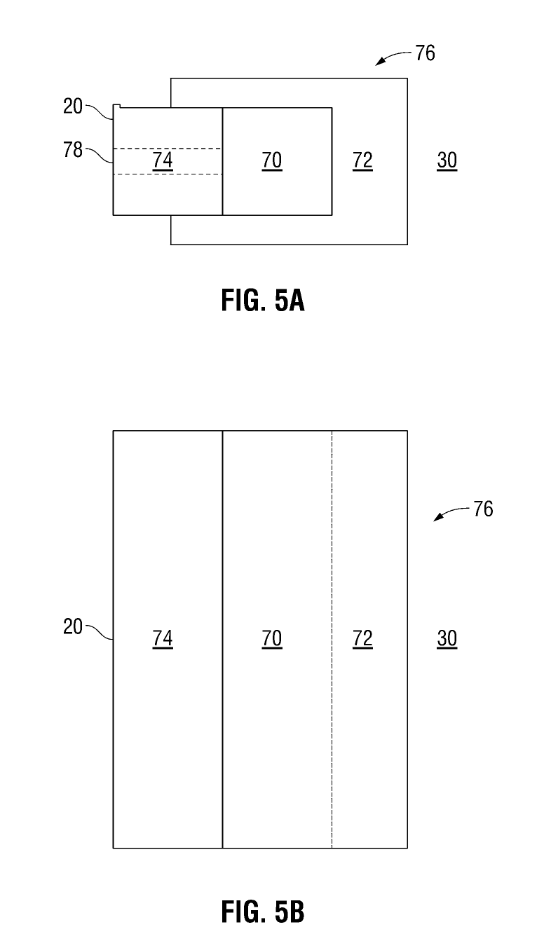

Referring now to FIGS. 5A and 5B, there is illustrated a wall adapter system 76 which preferably eliminates the need for additional side moulding required by many conventional installations. Once the cabinet 12 is suspended and installed there may be a gap between the side surfaces 18 and a wall, existing or other cabinet, or some other furniture, appliance, apparatus, or the like. This gap needs to be aesthetically covered while maintaining the ease and economical benefit of the suspended cabinet system 10. The wall adapter system 76 preferably includes a slide adapter 72. Slide adapter 72 is adjustable in order to substantially contact the wall 30 or other item adjacent to the installed cabinet 12.

Slide adapter 72 preferably adjustably mounts to the cabinet end section 74 (see also FIGS. 1 and 4). Adapter piece 70 is utilized to allow adjustability and stability of slide adapter 72. Preferably, adapter piece 70 is attached to the cabinet edge 74 through one or more screws through attachment holes 78. It should be understood that a variety of connection methods such as, but not limited to, nails, pins, glue and the like can be used to attach adapter piece 70 to cabinet edge 74. Still further, it should be understood that the attachment of slide adapter 72 to adapter piece 70 and/or cabinet edge 74 may be by a variety of connection methods and thus, the exact attachment of the wall adapter system 76 to cabinet 12 should not be viewed as a limitation herein. In another embodiment, wall adapter system 76 may have double slide connection capabilities. Thus, the double end wall adapter system 76 can aesthetically provide facades between cabinets 12 or other adjacent articles that are not the same depth (i.e. one or the other extends further from the wall 30 than the other).

In operation the suspended cabinet system 10 saves time and expense for installing cabinets 12. The cabinet 12, the back support flange 34, and the toe plate 32 are separately manufactured. Cabinet 12 is manufactured to include the mounting groove 42 and the back lip 44. It should be understood that in certain cases it may be possible to retrofit mounting groove 42 and back lip 44 onto a conventional or custom made cabinet and as such should not be viewed as being outside the scope of the present disclosure. The back support flange 34 is can be manufactured in various lengths or can be made in a convenient length which may be cut to a necessary length at installation time. The toe plate 32 may also be manufactured in various lengths or in convenient lengths intended to be cut to desired lengths at installation time. Preferably, toe plate 32 is manufactured with one planar section being substantially the conventional length and the second planar section 62 being a width sufficient to allow adjustment to properly bridge the space between the bottom of cabinet 12 and the floor 28.

The back support flange 34 is mounted on wall 30. It should be understood that the back support flange 34 is positioned on wall 30 at a height above the ground that will position the top surface 14 at the desired height. It should be further understood that the back support flange 34 is horizontally leveled against wall 30 using a conventional level. Cabinet 12 is mounted on the leveled back support flange 34 so that the back lip 44 engages contact area 38. At this point, in the installation process, cabinet 12 is level. If so desired, cabinet 12 may be more permanently attached to the wall 30 and the back support flange 34 through the use of nails, screws, bolts, glue, pins, staples, and the like.

Next the toe plate 32 is ready for attachment to bottom support 26. It should be appreciated that this step requires substantially no advanced planning regarding the dimensions of toe plate 32 or any inconsistences of the floor surface 28. The installer can visually place toe plate 32 adjacent to the side surface 64 of bottom support 26. If the floor 28 is fairly even, planar section 60 may be attached to bottom support 26. If the floor surface 28 is uneven or sloped, planar section 62 may be used. Planar section 62 is marked or scribed to reflect the floor 28 slope or unevenness and can be cut to aesthetically cover the space between the bottom of cabinet 12 and the floor 28. It should be appreciated that if cabinet 12 has to be installed in a lower position or a higher position, relative to floor surface 28, either planar section 60, 62, may be used as the section to be trimmed for the proper aesthetic fit.

Preferably, after cabinet 12 is positioned, wall adapter system 76 may be installed if necessary. Wall adapter system 76 will provide an aesthetic connection between cabinet 12 and any adjacent wall, cabinet, furniture, or other fixture and/or structure. It should be understood that depending on the cabinet configuration either a single slide adapter 72 or a double side slide adapter may be used. It should be further understood that additional facades may be added to one or both side surfaces 18 if they are to be exposed. Such facades will preferably extend to the floor surface 28.

Obviously, other modifications and variations of the disclosed system are possible in the light of the above teachings. It is therefore to be understood that changes may be made in the particular embodiments described above which are within the full intended scope as defined in the appended claims.

While the present system and method has been disclosed according to the preferred embodiment, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the system or methods disclosed herein to those particular embodiment configurations. These terms may reference the same or different embodiments, and are combinable into aggregate embodiments. The terms “a”, “an” and “the” may also mean “one or more”.

None of the description in this specification should be read as implying that any particular element, step or function is an essential element which must be included in the claim scope. The scope of the patented subject matter is defined by the allowed claims and their equivalents. Unless explicitly recited, other aspects of the instant disclosure as described in this specification do not limit the scope of the claims. Because many varying and different embodiments may be made within the scope of the novel concept(s) herein taught, and because many modifications may be made in the embodiment herein detailed in accordance with the descriptive requirements of the law, it is to be understood that the details herein are to be interpreted as illustrative and not in a limiting sense.

I claim:

1. A cabinet suspension system for economically and efficiently installing and leveling a cabinet comprising:
a cabinet, said cabinet having a top side, a back side, a front side, a bottom side and two flank sides connecting said front side and said back side;
said back side defining a mounting groove therein;
a wall support flange, said wall support flange being capable to suspend said cabinet therefrom, wherein said cabinet is suspended in close proximity to a floor surface; and
a plate, said plate being mountable to said cabinet and adjustable for compensation of substantially any irregularities of said floor surface.

2. The cabinet suspension system of claim 1, further comprising:
said mounting groove having a bottom end and a top end; and
said top end having a lip extending therefrom in a direction toward said bottom end, wherein said lip mates with said wall support flange, and wherein said mating suspends said cabinet in close proximity to said floor surface.

3. The cabinet suspension system of claim 1, wherein said wall support flange is fixedly attached to a rigid structure in a manner so as to be horizontally level.

4. The cabinet suspension system of claim 1, further comprising:
said plate having a first planar section and a second planar section;
said first planar section and said second planar section each having a lengthwise edge, wherein said first and second planar sections are joined at respective lengthwise edges so as to form a substantially right angle connection, and wherein said connection results in said first planar section being substantially perpendicular to said second planar section; and
said second planar section being wider with respect to said first planar section.

5. The cabinet suspension system of claim 4, further comprising:
said cabinet having a planar support member attached to said bottom side; and
said plate being detachably attached to said planar support member.

6. The cabinet suspension system of claim 4, wherein said first planar section and said second planar sections are integral.

7. The cabinet suspension system of claim 1, further comprising at least one facade member that attaches to at least one flank side, wherein said facade member extends from at least said top side to be in close proximity of said floor surface.

8. The cabinet suspension system of claim 1, further comprising:
said flank sides each having a front edge;
a system for economically and aesthetically adjusting a variable space between said at least one front edge and a wall and/or other structure;
said system comprising an adjustable member capable of moving between said at least one front edge and a wall and/or other structure; and
said system comprising a spacer member, wherein said spacer member is positioned between said at least one front edge and said adjustable member, and wherein said adjustable member is detachably attached to said spacer member and said at least one front edge after being adjusted to extend from said at least one front edge to said wall and/or other structure.

9. A method for economically installing and leveling a cabinet comprising the steps of:
providing a cabinet, said cabinet having a top side, a back side, a front side, a bottom side and two flank sides connecting said front side and said back side;
manufacturing a mounting groove in said back side;
mounting a wall support flange to a rigid structure;
horizontally leveling said wall support flange; and
suspending said cabinet from said wall support flange, wherein said suspension results from mating said mounting groove and said wall support flange, and wherein said cabinet is suspended in close proximity to a floor surface.

10. The method of claim 9, further comprising the step of constructing said mounting groove to have a lip extending from a top side of said mounting groove in a downward, wherein said lip mates with said wall support flange, and wherein said mating suspends said cabinet in close proximity to said floor surface.

11. The method of claim 9, further comprising the steps of:
forming a plate having a first planar section and a second planar section;
joining said first planar section and said second planar section along respective lengthwise edges so as to form a substantially right angle connection, wherein said connection results in said first planar section being substantially perpendicular to said second planar section; and
manufacturing said second planar section so as to be wider with respect to said first planar section.

12. The method of claim 11, further comprising the steps of:
attaching a planar support member to said bottom side of said cabinet; and
detachably attaching said plate to said planar support member.

13. The method of claim 12, further comprising the step of cutting said plate so as to cover the distance between said cabinet bottom and said floor surface.

14. The method of claim 9, further comprising the steps of:
attaching at least one facade member to said at least one flank side; and
extending said facade member extends from at least said top side downward to be in close proximity of said floor surface.

15. The method of claim 9, further comprising the steps of:
forming a front edge on each of said flank sides;
providing a system for economically and aesthetically adjusting a variable space between said at least one front edge and a wall and/or other structure;
providing an adjustable member capable of moving between said at least one front edge and a wall and/or other structure;
positioning a spacer member between said at least one front edge and said adjustable member;
adjusting said adjustable member to extend from said at least one front edge to said wall and/or other structure; and
attaching said adjustable member to said spacer member and said at least one front edge.

16. A cabinet suspension system for installing and leveling a cabinet comprising:
a cabinet, said cabinet having a top side, a back side, a front side, a bottom side and two flank sides connecting said front side and said back side;
said back side defining a mounting groove therein;
a wall support flange, said wall support flange being capable to suspend said cabinet therefrom, wherein said cabinet is suspended in close proximity to a floor surface;
said mounting groove having a bottom end and a top end;
said top end having a lip extending therefrom in a direction toward said bottom end, wherein said lip mates with said wall support flange, and wherein said mating suspends said cabinet in close proximity to said floor surface;
a plate having a first planar section and a second planar section;
said first planar section and said second planar section each having a lengthwise edge, wherein said first and second planar sections are joined at respective lengthwise edges so as to form a substantially right angle connection, and wherein said connection results in said first planar section being substantially perpendicular to said second planar section; and
said second planar section being wider with respect to said first planar section.

17. The cabinet suspension system of claim 16, wherein said first planar section and said second planar sections are integral.

18. The cabinet suspension system of claim 16, wherein said wall support flange is fixedly attached to a rigid structure in a manner so as to be horizontally level.

19. The cabinet suspension system of claim 16, further comprising:
said cabinet having a planar support member attached to said bottom side; and
said plate being detachably attached to said planar support member.

20. The cabinet suspension system of claim 16, further comprising at least one facade member that attaches to at least one flank side, wherein said facade member extends from at least said top side to be in close proximity of said floor surface.
